(19) United States
(12) Patent Application Publication
(10) Pub. No.: US 2011/0185997 A1
(43) Pub. Date: Aug. 4, 2011

(54) START-UP UNIT FOR CONSTANTLY ENGAGED / COUPLED, COMBUSTION ENGINES

(75) Inventors: Fernando Comandolli, Bairro Steffen Brusque (BR); Marcelo Peregrina Gomez, Bairro Steffen Brusque (BR)

(73) Assignee: ZEN SA INDÚSTRIA METALURGICA, Santa Catarina (BR)

(21) Appl. No.: 13/122,408

(22) PCT Filed: Oct. 2, 2009
(86) PCT No.: PCT/BR2009/000333

§ 371 Date: Apr. 2, 2011

(30) Foreign Application Priority Data
Oct. 2, 2008 (BR) PI0804052-4
Oct. 2, 2009 (BR) PCT/BR2009/000333

(51) Int. Cl. F02N 15/02

(52) U.S. Cl. 123/179.25

(57) ABSTRACT

The present invention is aimed at the technical field of starter systems in general, more specifically to a starter unit (1) for permanently engaged/coupled internal combustion engines. The starter unit (1) essentially comprises an electric motor (2), a speed reduction system with planetary gears (3) and a flywheel and torque transmission system with splines (4).

### PRESENTATION

The present invention is described within the technical area of start-up systems in general, referring more specifically to a start-up unit for constantly engaged/coupled engines that use torque and free spinning transmission with paddles and reduction through planetary gears.

### HISTORY AND STATE OF THE ART

The internal combustion engines need an auxiliary start-up system to begin their operation. These engines require a minimum rotation and a duration dependant from the building of the engine, its temperature and other parameters.

In the current state of the art, there are manual or automatic start-up systems. In the case of the automatic start-up, the electric start-up system is the most used and it is characterized by the use of the start-up engine.

In practically all the vehicles with internal combustion engines there is an electric start-up engine. This engine is made up of two parts, one electric and one mechanic. The electric part is basically formed by a solenoid and an inductor. The mechanic part is represented by the casing, the linkage lever and the start-up propeller.

The start-up propeller's primary function is to transfer the torque from the electric engine to the internal combustion engine. This torque is limited by the construction of the propeller and by the materials used.

The combustion engines have a minimum rotation regime for their operation called slow run, this being at least twice more than the start-up rotation. Due to this condition, the propeller has a secondary function called free spinning, which is extremely important to avoid an over-rotation of the start-up engine.

After the beginning of the combustion engine's operation, an increase on the start-up rotation takes place, for a greater rotation, which at least reaches the slow run value. This increase in the rotation, because of the great transmission relation between the combustion engine and the start-up engine, if the free spinning is not being used, would generate extreme rotations on the inductor and would cause damage to the induced axis (centrifugation of the reel, warps, among others), and/or to other internal components.

Besides that, the noise is quite intense since the gearing is external and there cannot be any type of lubrication between the cogwheel and the rack. Dust could also be an agent that may cause problems for the service life of the propeller if this does not have a good gasket system against external filtrations, considering that this system is exposed.

“Cog against cog” collisions between the cogwheel and the rack can also occur, which may lead to a failed start-up because the solenoid cannot complete its displacement, impeding the joining of the contacts and thus making the actuation of the electric engine impossible.

Given the current characteristics that the start-up propellers have, their service life is limited, making their manufacturing and improvements not viable, financially. Besides having a dry gearing, the current construction forces the assembly of the system to happen specifically on the rack.

The automotive industry area is demanding more and more products that have a greater service life at lowers prices from their providers. Considering this, their providers look for new technologies to be more competitive than their competitors.

### Improvements on the Current State of the Art

The start-up unit is different from the start-up engine because it is a component of the combustion engine installed on the basic engine, independent from its application. This characteristic gives the invention an important innovation, because the combustion engine's manufacturer will have a unique version of the start-up unit, therefore reducing the cost with an increase of the production volume and the development of new applications.

The Start-Up Unit eliminates the need to use the flywheel rack, fork and solenoid and eliminates the restrictions to the project caused by the application of the start-up engine. The flywheel of the engine means a reduction on the complexity.

The new start-up system presented here discards the use of components such as: fork, solenoids, rack and some electric cables. In this way it makes a solution for the start-up of combustion engines which is simpler and more efficient, available, because of the fact that the system is constantly engaged and mounted on the internal part of the combustion engine. Having this, the system is always bathed in oil, which reduces the friction between the moving parts and makes the contamination of the system due to external agents, impossible.

### Description of the Invention

The present invention consists of the use of a versatile, efficient and functional torque and free spinning transmission system transferred by mechanical paddles, where the set is called “start-up unit for combustion engines, constantly engaged”, which is formed by the union of a planetary gear reduction system, an electric engine and a free spinning system with paddles which, together, for a more efficient, cheap, silent and more durable start-up system.

The system proposes the torque and free spinning transmission because of the use of paddles, where the set stays permanently engaged, starting to rotate freely after the start-up of engines or similar feature. To generate the necessary torque and rotation for the start-up, it uses a reduction through planetary gears allowing the use of an ideal relation between weight, torque and power. That system's purpose is to reduce the manufacturing costs, improve performance, considerably reduce the noise, increase the service life and eliminate some of the existing components of the conventional start-up system.

### Description of its Operation

The present invention operates starting from the turning or the ignition key of the combustion engine. The ignition key leads current to the electric engine which, as a consequence, puts the inductor in motion. This motion is transferred to the planetary gear reduction system which modifies the torque and exit rotation of the system, making it ideal for a combustion engine to start operating. At the end of the system there is a cogwheel with a free spinning function in one rotation direction that uses mechanical paddles in its operation.

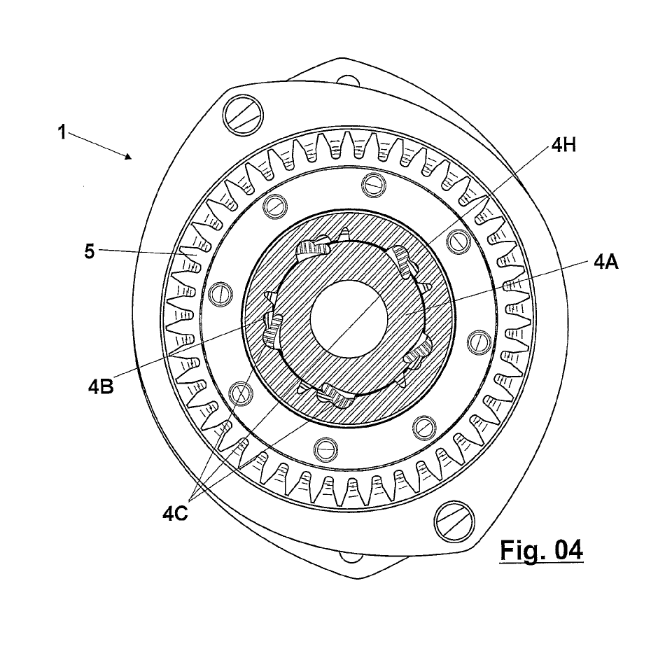

The paddles of the system are always being forced by the spring, so that they stay in an open position (locked) (FIG. 04)

The moment the combustion/explosion engine starts operating, the speed of the cogwheel starts being greater than the rotation of the inductor of the start-up system, while the system goes into free spinning.

When the engine starts operating and reaches the slow run, the inertia generated in the paddle beats the strength of the spring and closes the paddle on the system, which allows that the friction between the paddle and the axis is completely eliminated.

One the engine started operating, the user of the engine stops the start-up, turning the ignition key to the neutral position. In this moment, the electric engine is de-energized stopping the motion of the inductor and, consequently, of the planetary gears. Thus, only the cogwheel continues moving, engaged to the combustion engine and working in free spinning in relation to the rest of the start-up system.

The objectives, advantages and other important characteristics of the invention being valued, can be easily understood when read together with the figures in the addendum, where:

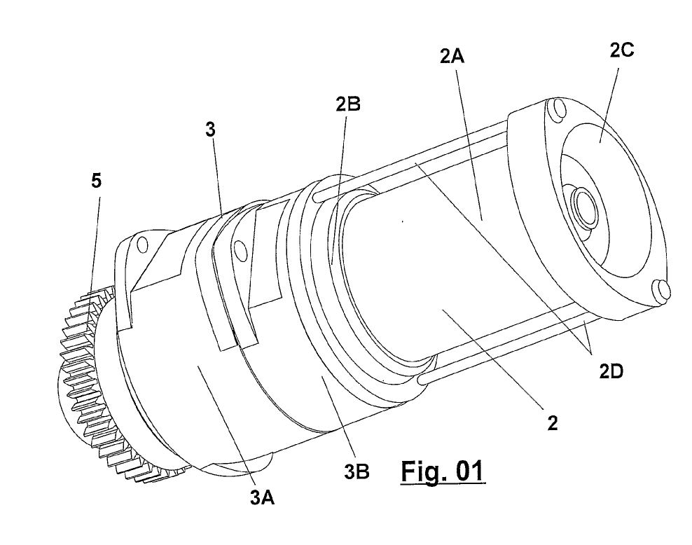

FIG. 01 represents a view of the start-up unit for constantly engaged/coupled combustion engines.

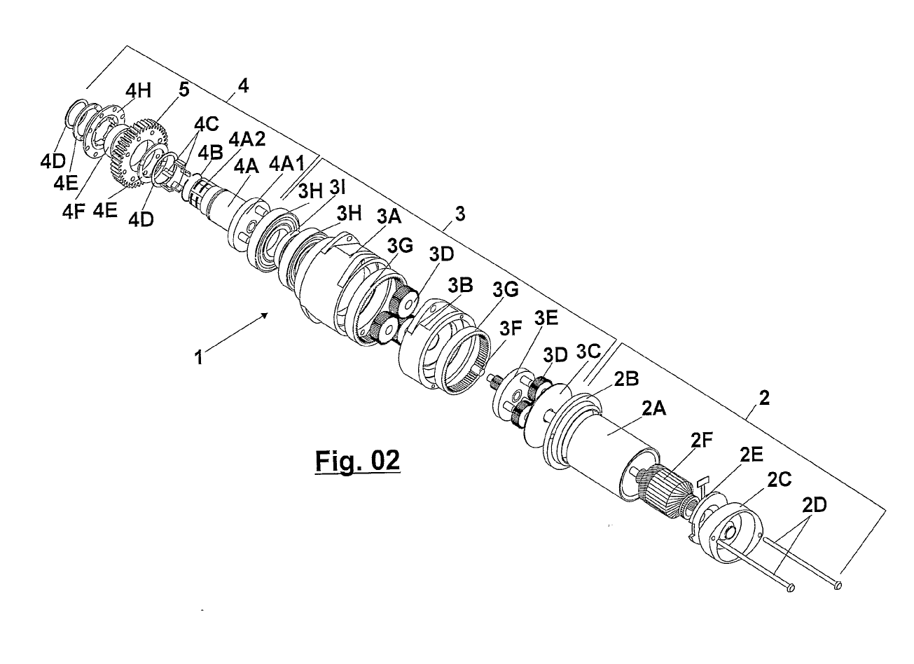

FIG. 02 represents a close-up view of the start-up unit for constantly engaged/coupled combustion engines.

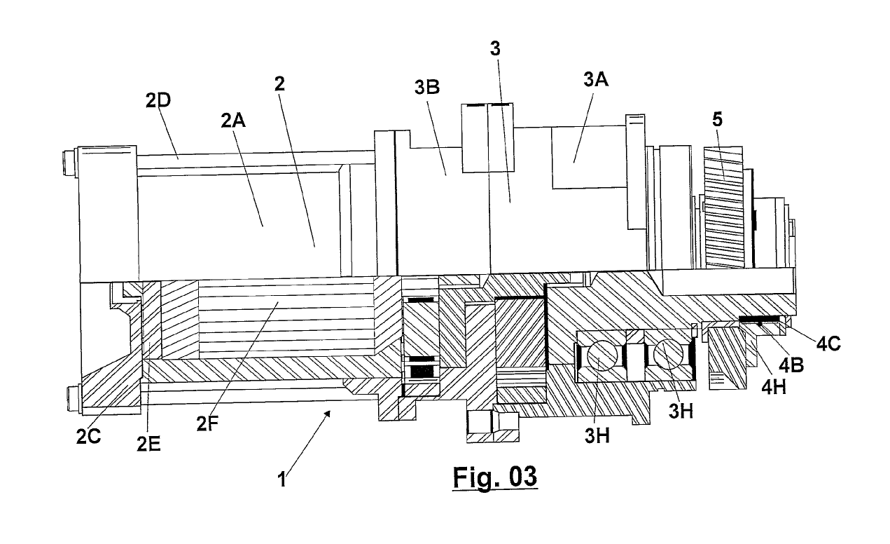

FIG. 03 represents a lateral-cut view of the start-up unit for constantly engaged/coupled combustion engines.

FIG. 4 represents a view from the top of the start-up unit for constantly engaged/coupled combustion engines.

As it can be inferred from the figures in the addendum, which illustrate and make up the present invention, “Start-Up Unit for Constantly Engaged/Coupled Combustion Engines”, it is understood as a start-up unit (1), made up of an electric engine (2), a planetary gear reduction system (3) and a free spinning system with paddles (4).

On FIG. 01 a view of the start-up unit is introduced (1), where one can see: the casing (2A), the intermediate hotbox (2B), the back hotbox (2C), and the screws (2D) of the electric engine (2); the front casing (3A) and the back casing (3B) of the planetary gears (3) and the engine gears (5).

On FIG. (02), a close-up view of the start-up unit (1) is presented, where one can see: the casing (2A), the intermediate hotbox (2B), the back hotbox (2C), the crews (2D), the brush support (2E) and the inductor (2F) of the electric engine (2); the front casing (3A), the back casing (3B), the lid (3C), the satellite gears (3D), the sun gear (3E), the stopper (3F), the crowns (3G), the bearings (3H), the spacer (3I) of the planetary gears (3); an axis (4A), provided with sun gear coupling (4A1) and a point with housings (4A2), which houses the spring (4B) and the paddles (4C), two pressure rings (4D), two washers (4E), a stopper (4F) and a coupling ring (4H), both from the free spinning system with paddles (4), and an engine gear (5).

On FIG. (3), a view of a cut section of the start-up unit (1) is shown, where the position of its components can be seen.

The pieces of this set can vary in size, format and material to adapt to any type of start-up unit system, but always keeping the same characteristics of the present invention.

By the set of arguments exposed, we are dealing with a product that will be well received by the assembly lines and the end users, because it is an extremely efficient and cheap product, which presents several improvements in relation to the current systems.

1) The “START-UP UNIT FOR CONSTANTLY ENGAGED/COUPLED COMBUSTION ENGINES” was developed to be applied as a start-up system for combustion engines or similar, comprising a start-up unit (1), made up by an electric engine (2), a planetary gear reduction system (3) and a free spinning system with paddles (4), which transfers the torque in one rotation direction, and spins freely in the opposite sense by the centrifugal principle of the paddles.

2) The “START-UP UNIT FOR CONSTANTLY ENGAGED/COUPLED COMBUSTION ENGINES”, according to claim 1 comprising use paddles (1) of at least 1 applied unit.

3) The “START-UP UNIT FOR CONSTANTLY ENGAGED/COUPLED COMBUSTION ENGINES”, according to claim 1 comprising the use of a planetary gear reduction system (3) or other reduction systems, if necessary.

4) The “START-UP UNIT FOR CONSTANTLY ENGAGED/COUPLED COMBUSTION ENGINES”, according to claim 1 comprising presenting a pressure wire or spring (4B) to place and fix the paddles (4C).
